(19) United States
(12) Patent Application Publication
(10) Pub. No.: US 2025/0164409 A1
(43) Pub. Date: May 22, 2025

(54) Systems and Methods for Detection of Defects in Machine Surfaces

(71) Applicants: Matthews International Corporation, Pittsburgh, PA (US); Matthews International GmbH, Vreden (DE)

(72) Inventors: Thomas HACKFORT, Ahaus-Alstätte (DE); Carsten KLEINGRIES, Vreden (DE)

(21) Appl. No.: 18/841,034

(22) PCT Filed: Mar. 1, 2023
(86) PCT No.: PCT/EP2023/055161

§ 371 Date: Aug. 23, 2024

Related U.S. Application Data
(60) Provisional application No. 63/315,354, filed on Mar. 1, 2022.

(51) Int. Cl. G01N 21/88; G01N 21/89; G01N 21/952

(52) U.S. Cl. CPC G01N 21/8851; G01N 21/952; G01N 2021/8861; G01N 2021/8893; G01N 21/89

(57) ABSTRACT

Systems and methods for identifying defects in manufacturing equipment are described. Camera-based image analysis can be used to improve product quality and reliability. Imagery of a machine surface can be repeatedly captured and analyzed by a processing device. Machine surfaces can be etched with landmarks to aid in removing distortion in imagery collected from the surfaces.

### CROSS-REFERENCE TO RELATED APPLICATIONS

The present application claims priority to and benefit of U.S. Provisional Application No. 63/315,354 filed Mar. 1, 2022, the disclosure of which is hereby incorporated by reference herein in its entirety.

### BACKGROUND

Impurities, such as dirt or particles, that are present in manufacturing equipment or the surrounding production environment can cause defects or otherwise degrade the performance of endless sheets that are used to form, for example, electrochemical cells and capacitors. These same impurities can also damage the equipment rollers, such as calendering rollers and nip rollers, by causing surface indents. The surface integrity of equipment rollers is critical because surface indents on equipment rollers can result in formed sheets for electrochemical cells that are outside of dimensional specifications as a result of improper handling and deformation of the powders used to form such sheets. Furthermore, the impurities themselves can become embedded within the endless sheets. These impurities and roller surface defects in such equipment can reduce electrochemical cell performance and reliability and increase the chance of product failure.

There exists a need for improved detection technologies for identifying and locating defects in manufacturing machine surfaces and/or produced electrodes.

### SUMMARY

In some embodiments, the system can include at least one camera and at least one processing device configured to detect a presence or absence of one or more defects in the machine surface using image input from the at least one camera.

In some embodiments, the at least one camera comprises two or more cameras.

In some embodiments, the at least one camera can be an optical camera.

In some embodiments, the at least one camera can have a resolution of at least about 0.5 mm.

In some embodiments, the at least one camera can be configured to capture image output periodically.

In some embodiments, the at least one camera can be configured to capture image input based on external input including at least one of sensor input and user input.

In some embodiments, the at least one camera can be configured to transmit the image input to the at least one processing device wirelessly.

In some embodiments, the at least one processing device can be further configured to receive and analyze the image input to detect the presence of one or more defects in the machine surface.

In some embodiments, the at least one processing device can be further configured to output a report or signal on the presence of defects in the machine surface.

In some embodiments, the at least one processing device can be further configured to count defects in the machine surface.

In some embodiments, the at least one processing device is configured to determine a physical location of defects in the machine surface.

In some embodiments, a method of detecting a presence or absence of defects in a machine surface used to produce an electrode can include providing at least one machine surface used to produce an electrode, obtaining at least one image of the machine surface using at least one camera, and analyzing the image using at least one processing device to detect the presence or absence of the defects.

In some embodiments, the method can further include obtaining the at least one image periodically.

In some embodiments, the method can further include obtaining the at least one image based on external input including at least one of sensor input and user input.

In some embodiments, the analyzing can be qualitative.

In some embodiments, the analyzing can be quantitative.

In some embodiments, the method can further include determining if the presence of defects is acceptable.

In some embodiments, the method can further include determining a physical location of defects in the machine surface.

In some embodiments, the method can further include applying a fluid to the machine surface before obtaining the at least one image.

### BRIEF DESCRIPTION OF THE DRAWINGS

The disclosure will become more fully understood from the following detailed description, taken in conjunction with the accompanying figures, in which:

FIG. 1 depicts a machine surface with an identifying landmark in accordance with an embodiment.

FIG. 2 depicts a system comprising a camera and a machine surface in accordance with an embodiment.

FIG. 3A depicts an illustrative example of a system comprising multiple cameras and a machine surface in accordance with an embodiment.

FIG. 3B depicts a second illustrative example of a system comprising multiple cameras and a machine surface in accordance with an embodiment.

FIG. 4 depicts a diagram of a process sequence for verifying a machine surface in accordance with an embodiment.

FIG. 5 depicts a comparison of a template and captured image of a machine surface in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

### DETAILED DESCRIPTION

This disclosure is not limited to the particular systems, devices and methods described, as these may vary. The terminology used in the description is for the purpose of describing the particular versions or embodiments only and is not intended to limit the scope.

### Systems

Systems can be assembled to aid in the detection of defects in machine surfaces used to manufacture electrodes.

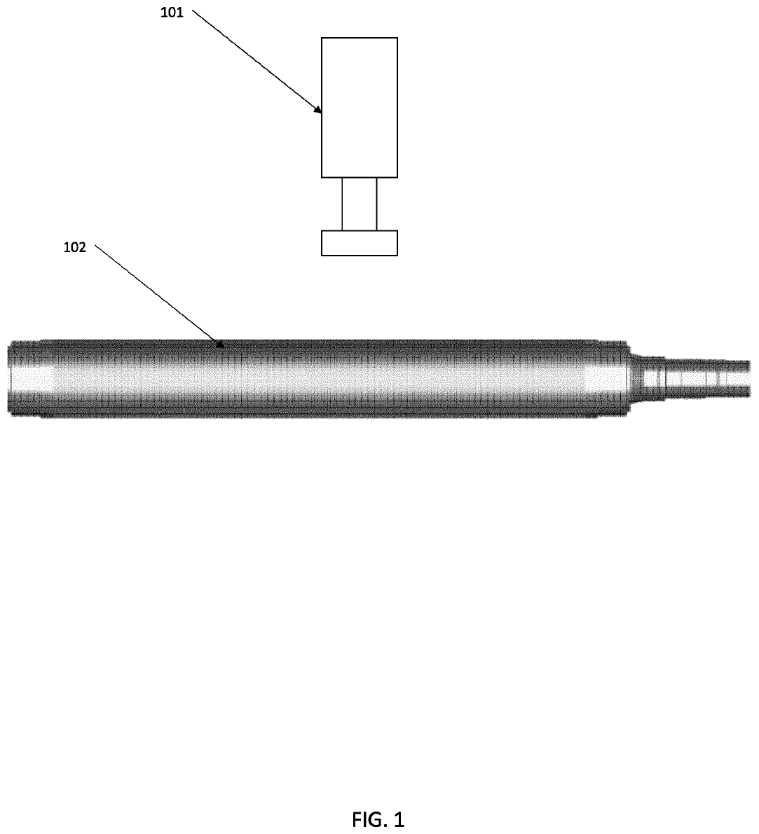

Referring to FIG. 1, a system can include at least one machine surface 102 used to produce an electrode, at least one camera 101, and a processing device (not shown) configured to detect the presence or absence of one or more defects in the machine surface using image input from the at least one camera.

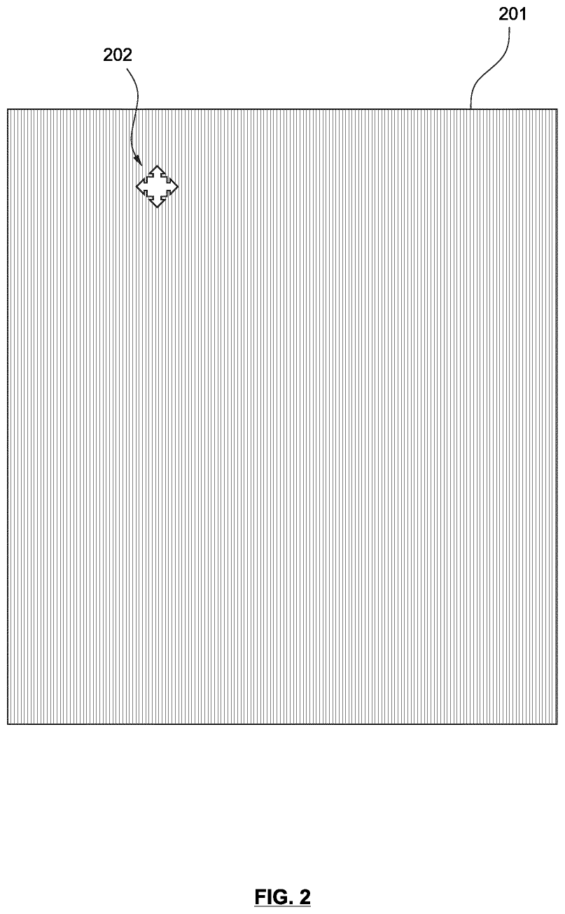

Referring to FIG. 2, the machine surface 201 can comprise one or more landmarks 202. The one or more landmarks 202 can be etched, via laser or chemical etching, into the machine surface 201. The one or more landmarks 202 may impart similar physical landmarks on an electrode created using the machine surface 201. The one or more landmarks 202 on the machine surface 201 and on the electrode can be used in optical tracking and identification.

The number of cameras can generally be any number such as 1 or 2 or more. For example, 1, 2, 3, 4, 5, 6, or more cameras can be used.

The at least one camera can generally be of any type. For example, the at least one camera can be an optical camera. The at least one camera can generally have any minimum resolution. For example, the minimum resolution can be at least about 0.5 mm, at least about 0.4 mm, at least about 0.3 mm, at least about 0.2 mm, or at least about 0.1 mm. The minimum resolution is at least sufficient to detect a defect. For example, a dent may be at least about 0.5 mm in width, so the minimum resolution can be selected to be at least about 0.5 mm to detect the dent.

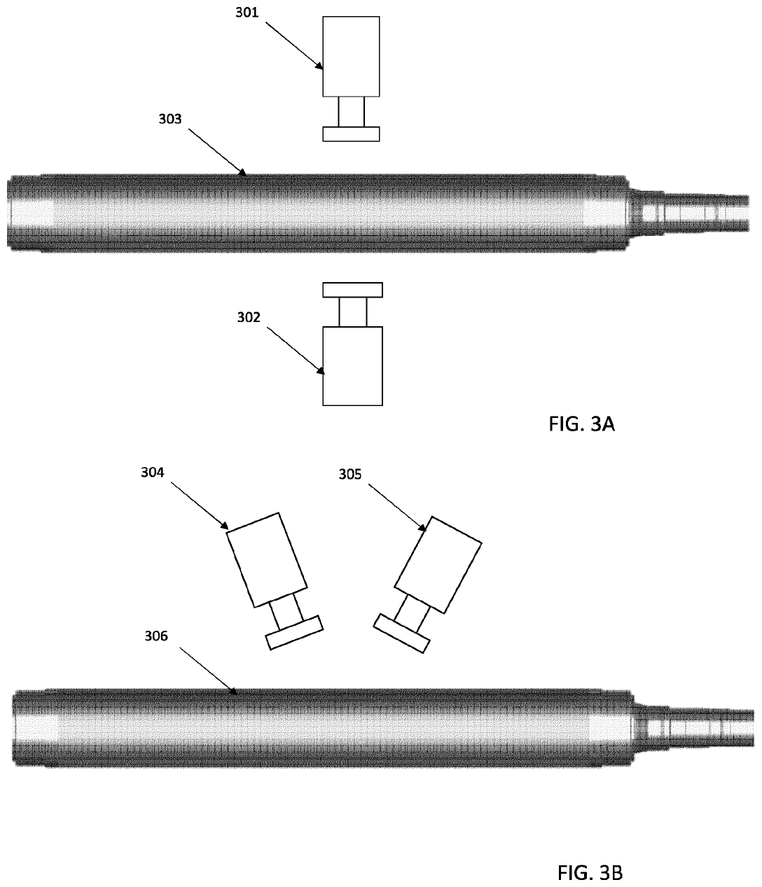

When two or more cameras are used in the system, the cameras can be configured in generally any orientation. For example, each camera can be oriented relative to the surface to be imaged. Each camera can generally be oriented at any angle relative to the surface to be imaged, such as about 0 degrees, about 5 degrees, about 10 degrees, about 15 degrees, about 20 degrees, about 25 degrees, about 30 degrees, and ranges between any two of these values. In examples where two or more cameras are used, the cameras can be oriented at the same or different angles relative to the surface to be imaged. Referring briefly to FIGS. 3A and 3B, two illustrative camera system orientations are presented. In some embodiments, two cameras 301/302 can be positioned on different surfaces of the roller 303. In some embodiments, two cameras 304/305 can be angled to face the same surface of the roller 306. In some embodiments, a liquid, such as water, can be present and can flow across rollers or machine surfaces to simplify the detection of defects. The system can further include a nozzle, a sprayer, or any other liquid handling system configured to apply the liquid to an electrode or machine surface.

The at least one camera can be configured to obtain at least one image and to transmit the at least one image to the processing device for analysis. The at least one camera can be configured to obtain images periodically or based on external input. In some embodiments, each image can comprise a still image. In some embodiments, the at least one image can comprise a video at a predetermined framerate. Image capture may be prompted based on external input from a sensor (e.g., temperature, humidity, etc.) or a user. For example, a temperature sensor may detect the machine surface has surpassed a predetermined threshold temperature, and capture imagery periodically to analyze product quality until the temperature drops below the threshold. The camera can be configured to transmit the image by wire/cable or wirelessly (such as through a network, Wi-Fi, or Bluetooth connection).

The processing device can generally be any type of processing device, such as a desktop computer, laptop computer, tablet, mobile phone, and so on. The processing device can be configured to receive the at least one image and to analyze the image to detect the presence or absence of one or more defects in the machine surface. The processing device can be configured to correct for any image distortion caused by the positioning of the camera. In some embodiments, image distortion correction can be based on a known placement of the camera. In some embodiments, image distortion correction can be performed automatically. Landmarks, such as those described herein, can aid in the automatic correction for image distortion. The processing device can be further configured to output a report or signal based on the presence and/or absence of defects in the machine surface.

The presence or absence of defects can be determined qualitatively (for example, “no defects” or “defects detected”) or quantitatively (for example, “zero defects”, “one defect”, “two defects”, etc.). In some embodiments, the processing device is configured to count defects in the machine surface. In some embodiments, the processing device can be configured to compare the number of detected defects against a standard or threshold value. Such an embodiment may be used where the machine surface is deemed acceptable if the number of detected defects is below the standard or threshold value and unacceptable if the number of detected defects is above the standard or threshold value. The processing device can additionally or alternatively compare the number of detected defects against an average number of defects over a time period to detect changes in production quality. Detected defects can be measured in a variety of ways. For example, the number of defects in a given area can be measured. In some examples, an acceptable number of defects may be not more than about 1 defect/m², not more than about 0.5 defects/m², not more than about 0.4 defects/m², not more than about 0.3 defects/m², not more than about 0.2 defects/m², not more than about 0.1 defects/m², and so on. In an ideal case, the number of defects would be less than the detection limit of the system, that is, no detected defects/m².

In some embodiments, the processing device can be configured to identify a number of detected defects. In some embodiments, the processing device can be configured to provide information regarding the physical location of the defect on the machine surface.

The machine surface used to produce an electrode can generally be any machine surface. Illustrative machine surfaces may include calendering rollers.

The system can further include at least one alarm. For example, the alarm can be configured to signal an operator when a machine surface has an unacceptable number of defects. The alarm signal can be auditory, optical, or haptic. The alarm signal can be an electrical signal sent to a remote processing device.

The system can further include at least one database of detected defects. The system can be configured to compare the obtained image or images against the database of previously detected defects. The system can be configured to add newly detected images of defects to the database.

The system can further include a non-transitory storage device storing a template image of the machine surface. The system can be configured to acquire new template images of the machine surface during operation.

### Methods

Methods can be performed to aid in the detection of defects in the machine surfaces used to manufacture such electrodes.

In an example, methods are provided for detecting the presence or absence of defects in at least one machine surface used for electrode manufacturing. In some embodiments, the methods comprise providing at least one machine surface, obtaining at least one image of the machine surface using at least one camera, and analyzing the at least one image using at least one processing device to detect the presence and/or absence of a defect. The number, types, and orientation of cameras used in such methods can be in the manner described above.

The at least one image can be obtained periodically or based on external input. The at least one image can be a still image or video. The type of image and image capture rate can be selected based on factors such as line speed and roller diameters. In some embodiments, the method further comprises applying a fluid to the machine surface before obtaining the at least one image.

The at least one image may be analyzed qualitatively (for example, “no defects” or “defects detected”) or quantitatively (for example, “zero defects”, “one defect”, “two defects”, etc.). Analyzing the at least one image may include comparing the number of detected defects against a standard or threshold value. In such an embodiment, a machine surface may be deemed acceptable if the number of detected defects in each analyzed image is below the standard or threshold value. Conversely, a machine surface may be deemed unacceptable if the number of detected defects in each analyzed image is above the standard or threshold value. Analyzing each image may additionally or alternatively include comparing the number of detected defects against an average number of defects over a period of time. In such an embodiment, the comparison may enable the detection of changes in production quality. In some embodiments, an image of the entire machine surface may be analyzed for defects. In some embodiments, portions of an image of a machine surface may be sampled.

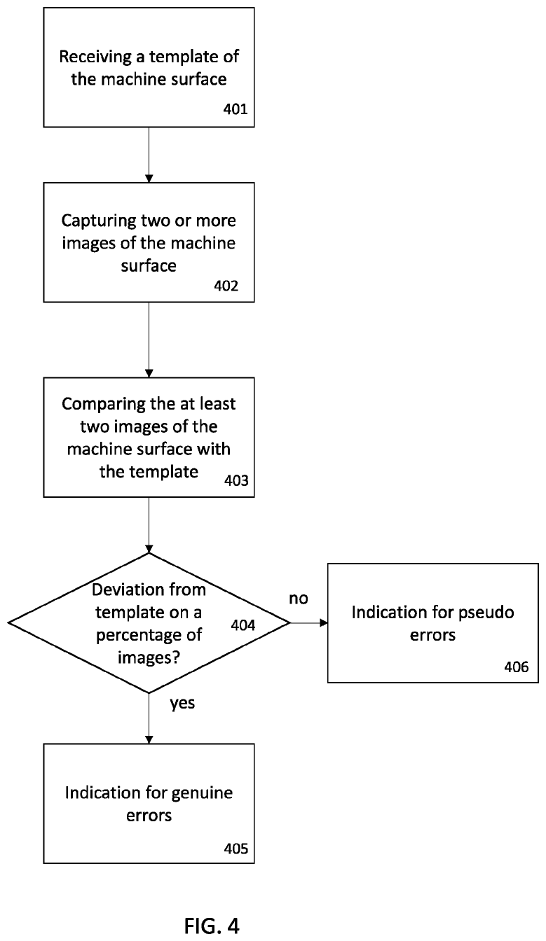

Analyzing the machine surface can further comprise comparing collected images with a template image. Referring to FIG. 4, a method can include receiving a template of the machine surface 401, capturing at least two images of the machine surface 402, comparing the at least two images of the machine surface with the template 403, and determining whether one or more of the at least two images have a deviation from the template 404. If the number of images depicting a specific deviation is below a predetermined threshold, the method can include indicating there are no errors 406. If the number of images depicting a specific deviation is above a predetermined threshold, the method can include indicating there are errors 405. The template 404 can be a single image showing deviation. Alternatively, in embodiments with multiple cameras, imagery from alternative sources can be used similarly to templates. By relying on imagery from multiple cameras, deviations created by a single camera (e.g., due to calibration errors or interference on the lens) can be ignored.

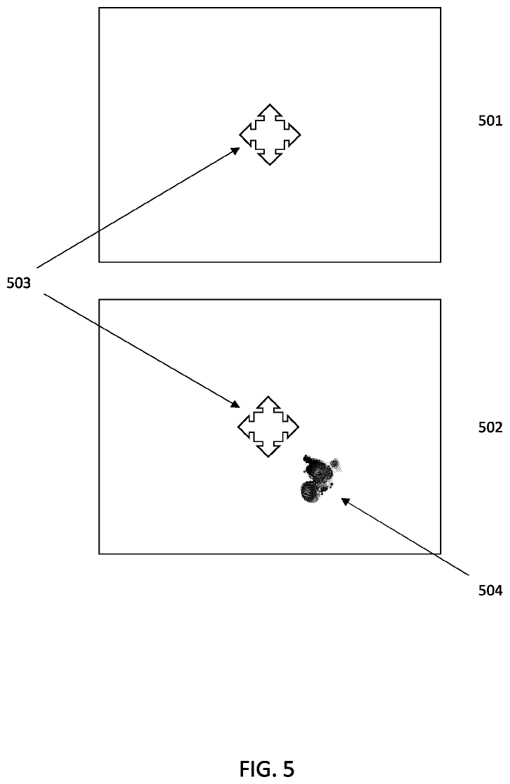

Referring to FIG. 5, an illustrative comparison between a template 501 and a collected image 502 is depicted. The template 501 and the collected image 502 can each include a landmark 503. Through comparison of the two images 501/502, a deviation 504 can be detected.

Image comparison can include preprocessing the images by the processing unit. Preprocessing can further include correcting for alignment and distortion. In embodiments featuring a landmark, the processing unit can distort and align the landmark to match the template image. Preprocessing can further include other image corrections including, but not limited to, saturation, contrast, and color selection.

Image comparison can utilize machine-learning, a neural network, and/or artificial intelligence. Machine-learning for image comparison can include forming a training set. The training set can comprise images with known defects or images created to mimic defects using a template image.

Image comparison can include comparing the collected images and template on a pixel-by-pixel basis. Alternatively, pixels can be clustered an averaged for comparison.

The method can further include flowing a liquid, such as water, across the machine surface to improve detection of defects. The flowing liquid can change the reflective properties of the surface to improve image contrast.

The method can further include comparing the obtained image or images against at least one database of previously detected defects. The method can further include adding any newly detected images of defects to the database.

1. A system to detect defects in a machine surface used to produce an electrode, the system comprising:
at least one camera; and
at least one processing device configured to detect a presence or absence of one or more defects in the machine surface using image input from the at least one camera.

2. The system of claim 1, wherein the at least one camera comprises two or more cameras.

3. The system of claim 1, wherein the at least one camera is an optical camera.

4. The system of claim 1, wherein the at least one camera has a resolution of at least about 0.5 mm.

5. The system of claim 1, wherein the at least one camera is configured to capture image input periodically.

6. The system of claim 1, wherein the at least one camera is configured to capture image input based on external input comprising at least one of sensor input and user input.

7. The system of claim 1, wherein the at least one camera is configured to transmit the image input to the at least one processing device wirelessly.

8. The system of claim 1, wherein the at least one processing device is further configured to receive and analyze the image input to detect the presence or absence of one or more defects in the machine surface.

9. The system of claim 1, wherein the at least one processing device is further configured to output a report or signal based on the presence of defects in the machine surface.

10. The system of claim 1, wherein the at least one processing device is further configured to count defects in the machine surface.

11. The system of claim 1, wherein the at least one processing device is further configured to determine a physical location of defects in the machine surface.

12. A method of detecting a presence of defects in a machine surface used to produce an electrode, the method comprising:
providing at least one machine surface used to produce an electrode;
obtaining at least one image of the machine surface using at least one camera; and
analyzing the image using at least one processing device to detect the presence of the defects.

13. The method of claim 12, further comprising obtaining the at least one image periodically.

14. The method of claim 12, further comprising obtaining the at least one image based on external input comprising at least one of sensor input and user input.

15. The method of claim 13, wherein the analyzing is qualitative.

16. The method of claim 13, wherein the analyzing is quantitative.

17. The method of claim 13, further comprising determining whether the presence of defects is acceptable.

18. The method of claim 13, further comprising determining a physical location of defects in the machine surface.

19. The method of claim 13, further comprising applying a fluid to the machine surface before obtaining the at least one image.
